(19) United States
(12) Patent Application Publication
(10) Pub. No.: US 2024/0338858 A1
(43) Pub. Date: Oct. 10, 2024

(54) SPHERICAL SHEARLET-BASED COMPRESSION AND RECONSTRUCTION METHOD FOR THREE-DIMENSIONAL SCALAR INFORMATION

(71) Applicant: ZHEJIANG UNIVERSITY, Hangzhou (CN)

(72) Inventor: Yizhi SUN, Hangzhou (CN)

(21) Appl. No.: 18/617,608

(22) Filed: Mar. 26, 2024

(30) Foreign Application Priority Data
Mar. 31, 2023 (CN) 202310337079.6

(51) Int. Cl. G06T 9/00

(52) U.S. Cl. CPC G06T 9/001

(57) ABSTRACT

A spherical shearlet-based compression and reconstruction method for three-dimensional scalar information is disclosed. The method is used for processing data distributed in accordance to certain probability distribution in a three-dimensional space, and is especially suitable for processing random or deterministic scalar data having a spherical distribution feature under polar coordinates and being anisotropic on a sphere, including spatial data with physical significance and clinical observation data in biomedicine. In the present disclosure, on the basis of reasonably dividing the three-dimensional space into multiple concentric spherical layers, the three-dimensional data distribution is decomposed into multiple layers of spherical data. In each layer related spherical information is decomposed, and key information is extracted, compressed and stored by using the mathematical property of a spherical shearlet system, and the original three-dimensional data information can be reconstructed or approximately restored from extracted key data.

### CROSS-REFERENCE TO RELATED APPLICATIONS

The present application claims priority to Chinese Patent Application No. 202310337079.6, filed on Mar. 31, 2023, the content of which is incorporated herein by reference in its entirety.

### TECHNICAL FIELD

The present disclosure belongs to applied mathematics and computer graphics and particularly relates to a spherical shearlet-based compression and reconstruction method for three-dimensional scalar information.

### BACKGROUND

Conventional methods such as Fourier analysis, spline analysis and wavelet analysis which have been utilized in data processing are mostly based on Cartesian coordinates. Recently, scientific researchers applied deep learning methods to the learning of a simply connected set represented in a two-dimensional polar coordinate and observed a significant improvement compared to a conventional learning method by adopting a Cartesian orthogonal coordinate system, which means that the polar coordinate representation has inherent advantages in analyzing some two-dimensional data. In the processing of three-dimensional data, some dataset features are concentrated within the neighborhood of a two-dimensional spherical surface, and their distribution has linear singularity with respect to the two-dimensional curved surface. If a representation system with a spherical anisotropic structure is adopted, combined with three-dimensional polar coordinates, key information from such data usually can be captured in a more accurate and efficient way and stored-a spherical shearlet representation is one representation with such characteristic. However, so far there is no technical method for three-dimensional information compression and reconstruction based on a spherical shearlet representation.

### SUMMARY

Regarding the shortcomings of the existing technical methods, the present disclosure provides a spherical shearlet-based compression and reconstruction technical method for three-dimensional scalar information, which is used for decomposing, extracting, storing and reconstructing scalar data information meeting a certain distribution in a three-dimensional space, including data from a mass distribution with a spherical feature in the three-dimensional space or random data distributed according to certain probability distribution. In biomedicine, three-dimensional data of human heart, kidney and brain surface from ultrasound magnetic resonance and CT image are suitable for being processed by the spherical shearlet-based information compression and reconstruction method; and in nature, distribution data of earth surface ridges, submarine trenches and star surroundings may be analyzed by using this method as well.

A specific technical solution is as follows.

A spherical shearlet-based compression and reconstruction method for three-dimensional scalar information includes the following steps:
S1: decomposing a three-dimensional space or a set V in the three-dimensional space into nonintersecting concentric spherical layers, U_{i∈I}V_{[r}_{ᵢ}_{,r}_{ᵢ₊₁}_{]}=V, and partitioning, layer by layer, scalar data information X distributed in the three-dimensional space;
S2: setting a spherical layer selection mechanism F_{S}:X→F_{S}X={F_{S}Xᵢ}_{i∈I+} based on the type of the three-dimensional scalar data X, and extracting, layer by layer, spherical information to be processed by a discrete spherical shearlet system; and
S3: decomposing, extracting and storing the spherical data from each layer, by the discrete spherical shearlet system, to reconstruct three-dimensional data in the space. The discrete spherical shearlet system has the following expression:

$$\{ {S}_{j , k} := {S}_{{σ}_{j ,} {a}_{k}}^{α} \vert {σ}_{j} ∈ G , {a}_{k} ∈ ( 0 , ∞ ) , 0 < α < 1 \} \qquad ( 1 )$$

where {aₖ}_{k≥1} represents a sampling of the positive real axis, aₖ monotonically approaches zero; index α represents the degree of anisotropy, and the smaller a value of the index is, the higher the degree of anisotropy is; and G represents a finite or countable discrete subset of the orthogonal group SO(3), so that an integral, of a square-integrable function h on any sphere on the orthogonal group SO(3) has a discrete expression:

$${〈 h 〉}_{SO ( 3 )} = {\sum }_{{σ}_{j} ∈ G} h ( {σ}_{j}^{- 1} {z}_{0} ) {w}_{j} \qquad ( 2 )$$

where z₀ represents a selected pole on the sphere, and wⱼ represents a weight depending on G. The discrete system may be obtained from a single or a finite number of generation functions S^{α} through spherical dilation transform Dₐ and spherical rotation on a discretized parameter set. P₁ is a projection onto the space spanned by spherical harmonic functions of degrees n=1, 2, . . . , 1, and S^{α} needs to satisfy, for example, the following restriction condition:

$$\frac{1}{2 l + 1} {\int }_{0}^{∞} {‖ {P}_{l} {D}_{a} {S}^{α} ‖}_{2}^{2} {a}^{- 2 - α} da < ∞ , ∀ l \geq 0 \qquad ( 3 )$$

The discrete spherical shearlet system {S_{j,k}}_{j,k} has the ability of stable decomposition and reconstruction and has an adjustable anisotropic support, namely, in the case that S² is the two-dimensional sphere and R represents the real domain, inputted spherical information Xₛ:S²→R has the following reconstruction formula after certain normalization operation:

$${X}_{s} = {\sum }_{l \leq L} {P}_{l} {X}_{s} + {\sum }_{{σ}_{j} ∈ G} {\sum }_{k} {\sum }_{l > L} {X}_{s , j} {P}_{l} {S}_{j , k} ( {σ}_{j}^{- 1} {z}_{0} ) {S}_{j , k} \qquad ( 4 a )$$

$${X}_{s , j} = {w}_{j} {X}_{s} ( {σ}_{l}^{- 1} {z}_{0} ) \qquad ( 4 b )$$

where L represents a positive integer, Xₛ represents a distribution or a random variable that satisfies a square integrable condition. The spherical shearlet transform of Xₛ in discrete form has an expression:

$$SH ( {X}_{s} ; j , k ) := {\sum }_{l > L} {X}_{s , j} {P}_{l} {S}_{j , k} ( {σ}_{j}^{- 1} {z}_{0} ) , \qquad ( 5 )$$

and its calculation concerns further discretization of P₁S_{j,k}, which can be accomplished through calculation prior to performing the spherical shearlet transform.

Further, in the step S1, a specific implementation step of partitioning, layer by layer, the set and the scalar data information is as follows: letting V=R³ be the entire three-dimensional real space or a bounded set including to-be-processed data. Prior information is unnecessary for the method of the present disclosure, but if prior information of data distribution of the entire space exists and how many blocks the data are partitioned is known, the entire space may be pre-partitioned into several parts by using an appropriate data classification method, and then each part is used as V to be processed, respectively. V is partitioned into concentric spherical layers V_{[r}_{ᵢ}_{,r}_{ᵢ₊₁}_{]}, i∈I, that do not intersect with each other, according to the scale or size so of a local feature that needs to be extracted, so that rᵢ₊₁−rᵢ∝S₀, U_{i∈I} V_{[r}_{ᵢ}_{,r}_{ᵢ₊₁}_{]}=V, and at the same time, three-dimensional scalar data is partitioned correspondingly into {Xᵢ}_{i∈I}, where Xᵢ represents data of X in the concentric spherical layers V_{[r}_{ᵢ}_{,r}_{ᵢ₊₁}_{]}. The index set/represents a finite set or a countable set in the modeling sense and a finite set in the actual operation sense. Different probability measures u are selected to adapt to different data types, where the analyzed three-dimensional data distribution may be a continuous or discrete distribution. For example, a restriction of du onto the concentric spherical layers V_{[r}_{ᵢ}_{,r}_{ᵢ₊₁}_{]} may be defined to be dμ|v_{[r}_{ᵢ}_{,r}_{ᵢ₊₁}_{]}=Xᵢdv.

Setting a threshold N_{b}<<μ(V) according to actual needs, directly abandoning data in the concentric spherical layers V_{[r}_{ᵢ}_{,r}_{ᵢ₊₁}_{]} and letting Xᵢ=0, whenever a total data volume μ(V_{[r}_{ᵢ}_{,r}_{ᵢ₊₁}_{]})<N_{b} in V_{[r}_{ᵢ}_{,r}_{ᵢ₊₁}_{]}; or otherwise, further decomposing a data distribution in V_{[r}_{ᵢ}_{,r}_{ᵢ₊₁}_{]} into data distribution in each subdomain V_{i,k}, and V_{[r}_{ᵢ}_{,r}_{ᵢ₊₁}_{]}=UₖV_{i,k}. The selection of N_{b} shall ensure that the extraction of key information is not affected by abandoning data from a certain concentric spherical layer, while reducing the amount of calculation for analyzing data. The subdomains are located in a cone defined by the same radial sections with ∫X d\vec{v} as an apex if the subdomains V_{i,k} and V_{i+1,k′} in adjacent layers V_{[r}_{ᵢ}_{,r}_{ᵢ₊₁}_{]} and V_{[r}_{ᵢ₊₁}_{,r}_{ᵢ₊₂}_{]} have a common area element.

Setting r_{i,k,1}=r_{i,k,2}=r_{i,k,-1}=r_{i,k,-2}=rᵢ on each subdomain V_{i,k} that satisfies μ (V_{i,k})<δᵢμ (V_{[r}_{ᵢ}_{,r}_{ᵢ₊₁}_{]}), and δᵢ<<1; otherwise, setting

$${c}_{i}^{′} = {supX}_{j} , d {µ}^{c} {\vert}_{{V}_{i , k}} = {c}_{i}^{′} dv - d µ {\vert}_{{V}_{i , k}} , \qquad ( 6 a )$$

$${\overline{r}}_{i , k} = {argmin}_{r} {\int }_{{V}_{i , k}} {\vert \vert x \vert - r \vert}^{2} d {µ}^{c} , \qquad ( 6 b )$$

and letting r_{i,k,1}=infᵣ{r:μ({x∈V_{i,k}:r̅_{i,k}<|x|<r})>ε}, r_{i,k,2}=supᵣ{r:μ({x∈V_{i,k}:r<|x|<rᵢ₊₁})>ε}, r_{i,k,-1}=supᵣ{r:μ({x∈V_{i,k}:r<|x|<r̅_{i,k}})>ε}, and r_{i,k,-2}=infᵣ{r:μ({x∈V_{i,k}:rᵢ<|x|<r})>ε}, where the value ε represents an appropriately chosen threshold. In particular, replacing the expression (6b) by

$${\overline{r}}_{i , k} = {argmin}_{r} {\sum }_{x ∈ {V}_{i , k}} {\vert \vert x \vert - r \vert}^{2} {X}_{i , k} ( x )$$

to reduce the amount of calculation when data in V_{i,k} include a small amount of discrete data points.

Partitioning the subdomain V_{i,k} into two along r=r̅_{i,k} to obtain two fine subdomains V′_{i,k} and V″_{i,k} in the case that a certain given positive constant c satisfies r_{i,k,1}−r_{i,k,-1}≥c·s₀, and letting r′_{i,k,2}=r_{i,k,2}, r′_{i,k-2}=r_{i,k,1}, r″_{i,k,2}=r_{i,k,-1}, and r′_{i,k-2}=r_{i,k-2}. While in other subdomains, letting r′_{i,k,2}=r_{i,k,2}, r′_{i,k,-2}=r″_{i,k,2}=r̅_{i,k}, and r″_{i,k,-2}=r_{i,k,-2}, or letting r′_{i,k,2}=r_{i,k,2}, r′_{i,k,-2}=r_{i,k,-2}, and r″_{i,k,2}=r″_{i,k,-2}=rᵢ. In the above subdivision, when μ(V′_{i,k})<δᵢμ(V_{[r}_{ᵢ}_{,r}_{ᵢ₊₁}_{]}), data in V′_{i,k} may be abandoned directly while those in V″_{i,k} are retained. The steps are repeated to traverse all subdomains V_{i,k}, so that {V_{[r}_{ᵢ}_{,r}_{ᵢ₊₁}_{]}}_{i∈1} is updated till r_{i,k,1}−r_{i,k,-1} in each subdomain is a negligible quantity value and finally a group of subdomains {V_{[r}_{ᵢ}_{,r}_{ᵢ₊₁}_{]}}_{i∈I+} is obtained. This process further subdivides a region where data distribution has a prominent geometric feature, for example, a region that contains unconnected parts is partitioned into two connected subdomains to be processed, respectively, which is an adaptive refinement.

After finite times of partitions, pairing and combining the subdomains of V_{[r}_{ᵢ}_{,r}_{ᵢ₊₁}_{]} together with their {r′_{i,k,2}, r′_{i,k,-2}}_{V′}_{_{i,k}}, {r″_{i,k,2}, r″_{i,k,-2}}_{V″}_{_{i,k}} . . . to obtain a finite set {(r′_{i,2}, r′_{i,-2}):r′_{i,2}|V_{i,k}=r′_{i,k,2}, r′_{i,-2}|v_{i,k}=r′_{i,k,-2}} in V_{[r}_{ᵢ}_{,r}_{ᵢ₊₁}_{]}.

Further, the step S2 of setting an information selection mechanism F_{S}:X→F_{S}X={F_{S}Xᵢ}_{i∈I+} and decomposing data information in the three-dimensional space into multiple layers of spherical information F_{S}X for processing may, for example, adopt the following solution.

Defining 1_{W} as a characteristic function of a set W in the three-dimensional space, and considering a data distribution X=X_{c}=c_{W}·1_{W}, namely, X is a non-zero constant c_{W} on a locally connected space set W and almost everywhere zero on its complement W^{c}; and when each concentric spherical layer V_{[r}_{ᵢ}_{,r}_{ᵢ₊₁}_{]} of {V_{[r}_{ᵢ}_{,r}_{ᵢ₊₁}_{]} }_{i∈I+} is fully refined, letting the to-be-processed data be:

$$\{ \begin{matrix}{f}_{i}^{+} ( {ω}_{i , k} ) = \frac{{r}_{i , k , 2}}{{r}_{i}} \\ {f}_{i}^{-} ( {ω}_{i , k} ) = \frac{{r}_{i , k , - 2}}{{r}_{i}}\end{matrix} \qquad ( 7 )$$

where ω_{i,k}=(θ_{i,k}, φ_{i,k}) corresponds to directional coordinates of a subdomain V_{i,k}. The set W may correspond to, but not limited to, a three-dimensional cartoon figure with good local regularity.

Adopting the processing solution presented below, when data distributions X=Σₘ₌₁^{m} c_{W}_{ₘ}·1_{W}_{ₘ} or X=X_{c}+X_{d} include a non-negligible discrete component X_{d}=Σ_{p∈D}dₚδₚ, where D represents a finite discrete subset in the three-dimensional space, dₚ represents a positive integer, and δₚ represents the delta distribution at a point p. Defining Y to be a blockwise constant distribution that satisfies Y|v_{i,k}=∫y_{i,k}Xdv, and letting {cₜ, {V′ₜ}}_{t≤t̅} be a set defined deductively according to c₁=minY|v_{i,k} together with a subdomain V′₁=argminY|v_{i,k}, c₂=minᵥ_{_{i,k}}_{≠v′}_{₁}Y|_{V}_{_{i,k}}−c₁ together with a subdomain V′₂=argminᵥ_{_{i,k}}_{≠v′}_{₁}Y|ᵥ_{_{i,k}}, and so on; on each V_{[r}_{ᵢ}_{,r}_{ᵢ₊₁}_{]}, defining distributions Y₁|v_{i,k} and Yₜ|v_{i,k} deductively as:

$${Y}_{1} {\vert}_{{V}_{i , k}} = \{ \begin{matrix}{c}_{1} & Y {\vert}_{{V}_{i , k}} \neq 0 \\ 0 & Y {\vert}_{{V}_{i , k}} = 0\end{matrix} \qquad ( 8 a )$$

$$⋮$$

$${Y}_{t} {\vert}_{{V}_{i , k}} = \{ \begin{matrix}Y {\vert}_{{V}_{i , k}} - {\sum }_{s < t} {c}_{s} , Y {\vert}_{{V}_{i , k}} \neq 0 \\ 0 , Y {\vert}_{{V}_{i , k}} = 0 or {V}_{i , k} ∈ {U}_{s < t} \{ {V}_{s}^{′} \}\end{matrix} \qquad ( 8 b )$$

The to-be-processed data of a V_{[r}_{ᵢ}_{,r}_{ᵢ₊₁}_{]} layer satisfies the following expressions:

$$\{ \begin{matrix}{f}_{i}^{+} = {\sum }_{t \leq \overline{t}} {( {g}_{i}^{+} )}_{t} \\ {f}_{i}^{-} = {\sum }_{t \leq \overline{t}} {( {g}_{i}^{-} )}_{t}\end{matrix} \qquad ( 9 )$$

Finally, step S3 is performed: denoting the spherical information F_{S}X part that includes the to-be-processed data depending on spherical coordinates in the expression (7) or the expression (9) as {xⁱ}_{i∈I+}={F_{S}Xᵢ}_{i∈I+}, decomposing the spherical shearlet according to the expression (4a), and storing the coefficients {c_{j,k}^{i,+}}_{j,k} and {c_{j,k}^{i,-}}_{j,k} obtained from the spherical shearlet transform (5). The original three-dimensional data X is approximated by the following distribution:

$$\tilde{X} = {c}_{W} \cdot {\sum }_{i} ( {1}_{{U}_{i}^{+}} - {1}_{{U}_{i}^{-}} ) \qquad ( 10 )$$

where 1_{U}_{ᵢ}_{⁺} represents the characteristic function of a set Uᵢ⁺={x=|x|ω_{i,k}∈R³:|x|≤\tilde{x}^{i,+}(ω_{i,k})}, and 1_{U}_{ᵢ}_{^{−}}; represents the characteristic function of a set Uᵢ⁻={x=|x|ω_{i,k}∈R³:|x|≤\tilde{x}^{i,-}(ω_{i,k})}, and the following relations are satisfied:

$${\tilde{x}}^{i , +} = {\tilde{x}}_{L}^{i , +} + {\tilde{x}}_{H}^{i , +} = {r}_{i} {\sum }_{l \leq L} {P}_{l} {x}^{i , +} + {r}_{i} {\sum }_{j , k} {c}_{j , k}^{i , +} {S}_{j , k} \qquad ( 11 a )$$

$${\tilde{x}}^{i , -} = {\tilde{x}}_{L}^{i , -} + {\tilde{x}}_{H}^{i , -} = {r}_{i} {\sum }_{l \leq L} {P}_{l} {x}^{i , -} + {r}_{i} {\sum }_{j , k} {c}_{j , k}^{i , -} {S}_{j , k} \qquad ( 11 b )$$

so that on a finite (i, j, k) index set there are:

$${\sum }_{i} {‖ {x}^{i , +} - {x}_{L}^{i , +} - {\sum }_{j , k} {c}_{j , k}^{i , +} {S}_{j , k} ‖}_{B} \leq {ε}^{′} {\sum }_{i} {‖ {x}^{i , +} ‖}_{B} \qquad ( 12 a )$$

$${\sum }_{i} {‖ {x}^{i , -} - {x}_{L}^{i , -} - {\sum }_{j , k} {c}_{j , k}^{i , -} {S}_{j , k} ‖}_{B} \leq {ε}^{′} {\sum }_{i} {‖ {x}^{i , -} ‖}_{B} , \qquad ( 12 b )$$

where ε′<<1 is chosen according to required accuracy, ∥·∥_{B} represents a norm that may reflect data singular feature in space B adapted to the spherical shearlet system, and \tilde{x}_{H}ⁱ represents an approximation of a part of spherical data that is not of low degree. A corresponding shearlet coefficient has predictable sparsity in a case that F_{S}X has a linear singularity property on the sphere. The number of layers needing to be calculated is usually finite, so the calculation efficiency is determined by the efficiency of spherical shearlet representation.

Beneficial effects of the present disclosure are as follows:

In the present disclosure the three-dimensional data distribution is decomposed into multiple layers of spherical data through reasonably partitioning the three-dimensional space into a plurality of concentric spherical layers, and by using the spherical shearlet system the three-dimensional space scalar data in each layer are decomposed, compressed and reconstructed under a polar coordinate system. The spherical shearlet representation has foreseeable superiority over conventional methods in the aspect of processing scalar data with a spherical distribution feature in the three-dimensional space, especially those with a curvelinear singular distribution on the sphere.

### BRIEF DESCRIPTION OF DRAWINGS

FIG. 1 is a schematic flowchart of the spherical shearlet-based compression and reconstruction method for three-dimensional scalar information provided by the present disclosure.

FIG. 2 is an illustration of data distribution in a concentric spherical layer.

FIG. 3 is a schematic diagram of a concentric spherical layer V_{[r}_{ᵢ}_{,r}_{ᵢ₊₁}_{]} with a cone contained inside.

### DESCRIPTION OF EMBODIMENTS

The present disclosure is described below in detail according to main flows and functions of a method. Specific embodiments and accompanying conceptual drawings described here are merely for explaining the present disclosure instead of limiting the present disclosure, and optimization of a calculation quantity and the like in specific implementations is not discussed.

This method is mainly used for processing scalar data information in a three-dimensional space, including data from a mass distribution with a spherical feature in the three-dimensional space or random data distributed according to certain probability distribution. At the technical level, data whose three-dimensional space distribution coordinates can be inputted into a computer in matrix form and calculated, can be processed by this technical method, although the present disclosure is not described in a matrix language. In biomedicine, three-dimensional ultrasound, magnetic resonance and CT image data of structures such as heart, kidney and brain surface of people are suitable for being processed by the spherical shearlet-based information compression and reconstruction method; and in nature, distribution data of earth surface ridges, submarine trenches and star surroundings may be analyzed by using this method as well.

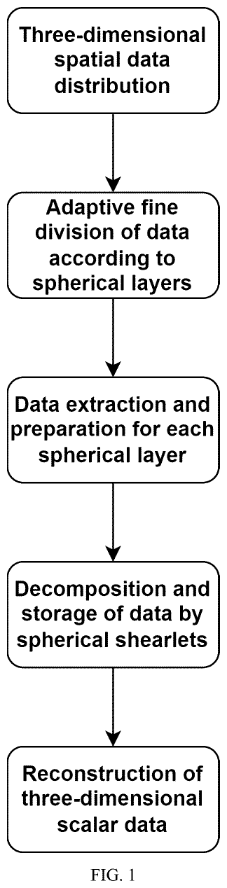

As shown in a schematic flowchart FIG. 1, a method of the present disclosure includes the following three steps:
S1: three-dimensional image data V is decomposed into a plurality of concentric spherical layers under polar coordinates, U_{i∈I}V_{[r}_{ᵢ}_{,r}_{ᵢ₊₁}_{]}=V, and acquired scalar data information X distributed in the three-dimensional space is partitioned layer by layer.
S2: a spherical layer selection mechanism F_{S}:X→F_{S}X={F_{S}Xᵢ}_{i∈I+} is set according to a type of the three-dimensional scalar data X, and spherical data information to be processed by a discrete spherical shearlet system is extracted layer by layer; and
S3: the spherical data from each layer are decomposed, extracted and stored by the discrete spherical shearlet system and then data in the three-dimensional space are reconstructed. The discrete spherical shearlet system has an expression:

$$\{ {S}_{j , k} := {S}_{{σ}_{j ,} {a}_{k}}^{α} \vert {σ}_{j} ∈ G , {a}_{k} ∈ ( 0 , ∞ ) , 0 < α < 1 \} \qquad ( 1 )$$

where {aₖ}_{k≥1} represents a sampling of the positive real axis, aₖ monotonically approach zero, and δ′>0 exists, so that |aₖ−aₖ₊₁|<δ′; index α represents the degree of anisotropy, and the smaller a value of the index is, the higher the degree of anisotropy is; and G represents a finite or countable discrete subset of an orthogonal group SO(3), so that an integral of a square-integrable spherical function h on the orthogonal group has a discrete expression:

$${〈 h 〉}_{SO ( 3 )} = {\sum }_{{σ}_{j} ∈ G} h ( {σ}_{j}^{- 1} {z}_{0} ) {w}_{j} \qquad ( 2 )$$

where z₀ represents a selected pole on the sphere, and w; represents a weight depending on G. The discrete spherical shearlet system may be obtained from a single or a finite number of generation function S^{α} through spherical dilation transform Dₐ and spherical rotation on a discretized parameter set. P₁ is a projection onto the space spanned by spherical harmonic functions of degrees n=1, . . . , 1, and the generation functions S^{α} need to satisfy, for example, the following restriction condition:

$$\frac{1}{2 l + 1} {\int }_{0}^{∞} {‖ {P}_{l} {D}_{a} {S}^{α} ‖}_{2}^{2} {a}^{- 2 - α} da < ∞ , ∀ l \geq 0 \qquad ( 3 )$$

The discrete spherical shearlet system {S_{j,k}}_{j,k} has the function of stably decomposing and reconstructing spherical information and has an adjustable anisotropic support, namely, in a case that S² is a two-dimensional sphere and Rsymbolizes real domain, inputted spherical information Xₛ:S²→R after normalization has a construction formula:

$${X}_{s} = {\sum }_{l \leq L} {P}_{l} {X}_{s} + {\sum }_{{σ}_{j} ∈ G} {\sum }_{k} {\sum }_{l > L} {X}_{s , j} {P}_{l} {S}_{j , k} ( {σ}_{j}^{- 1} {z}_{0} ) {S}_{j , k} \qquad ( 4 a )$$

$${X}_{s , j} = {w}_{j} {X}_{s} ( {σ}_{j}^{- 1} {z}_{0} ) \qquad ( 4 b )$$

where L represents a positive integer, Xₛ represents a distribution that is assumed to satisfy a square integrable condition ∫ₛ_{²}|Xₛ|²dω<∞, and a spherical shearlet transform of Xₛ in discrete form has an expression:

$$SH ( {X}_{s} ; j , k ) = {\sum }_{l > L} {X}_{s , j} {P}_{l} {S}_{j , k} ( {σ}_{j}^{- 1} {z}_{0} ) . \qquad ( 5 )$$

The specific calculation of the expression (5) concerns further discretization of P₁S_{j,k}, which may be obtained through calculation prior to performing the spherical shearlet transform.

In the step S1, a specific implementation step of partitioning the space set and the scalar information layer by layer is as follows:

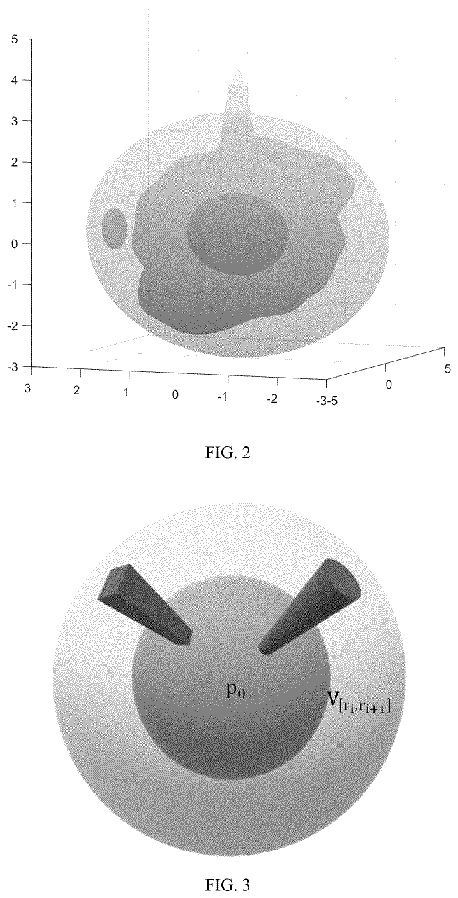

V represents the entire three-dimensional real space R³ or a bounded set including to-be-analyzed data. Prior information is unnecessary for the method of the present disclosure, but if prior information of data distribution of the entire space exists and how many blocks the data are partitioned is known, the entire space may be pre-partitioned into several parts by using an appropriate data classification method, and then each part is used as V to be processed, respectively. V is partitioned into nonintersecting concentric spherical layers V_{[r}_{ᵢ}_{,r}_{ᵢ₊₁}_{]}, where i∈I, according to the scale or size s₀ of a local feature that needs to be extracted, so that rᵢ₊₁−rᵢ∝S₀, U_{i∈I}V_{[r}_{ᵢ}_{,r}_{ᵢ₊₁}_{]}=V, and at the same time, three-dimensional data is partitioned correspondingly into {Xᵢ}_{i∈I}, where Xᵢ represents data of X contained in the concentric spherical layers V_{[r}_{ᵢ}_{,r}_{ᵢ₊₁}_{]}. The index set/is a finite set or a countable set in the model sense and is a finite set in the actual operation sense. If a spatial measure dv is given a certain coordinate to become a volume element d\vec{v} with a direction, a common center of the concentric spherical layers V_{[r}_{ᵢ}_{,r}_{ᵢ₊₁}_{]} can be chosen as ∫X d\vec{v}, and an origin of coordinates may be reset here for the convenience of subsequent calculation and operation. As analyzed data may form a continuous distribution or a discrete distribution, different probability measures u are selected according to different data types. For example, the restriction of dμ onto the concentric spherical layers V_{[r}_{ᵢ}_{,r}_{ᵢ₊₁}_{]} may be taken to be dμ|v_{[r}_{ᵢ}_{,r}_{ᵢ₊₁}_{]}=Xᵢdv. FIG. 2 is an illustration of data distribution in a concentric spherical layer, in which the main part of data has a spherical distribution feature, and some non-negligible data set that is not necessarily connected to the main part, is distributed on the periphery.

A threshold N_{b}<<μ(V) is set according to actual needs, so that the concentric spherical layers V_{[r}_{ᵢ}_{,r}_{ᵢ₊₁}_{]} are abandoned directly by letting Xᵢ=0 in the case that the total data volume μ(V_{[r}_{ᵢ}_{,r}_{ᵢ₊₁}_{]})<N_{b} in V_{[r}_{ᵢ}_{,r}_{ᵢ₊₁}_{]}. Otherwise, a data distribution in V_{[r}_{ᵢ}_{,r}_{ᵢ₊₁}_{]} may be further decomposed into data distribution in each subdomain V_{i,k}, with V_{[r}_{ᵢ}_{,r}_{ᵢ₊₁}_{]}=UₖV_{i,k}. Selection of N_{b} is supposed to ensure that the extraction of key information is not affected by abandoning data from a certain concentric layer, and meanwhile the amount of calculation for analyzing entire data is reduced. As shown in the schematic diagram of a concentric spherical layer V_{[r}_{ᵢ}_{,r}_{ᵢ₊₁}_{]} in FIG. 3, the cone part corresponds to a certain subdomain V_{i,k} in space division, and all cones share a common apex p₀. Subdomains V_{i,k} and V_{i+1,k′} are located in a cone with p₀=∫X d\vec{v} as an apex defined by the same radial sections in the case that the subdomains V_{i,k} and V_{i+1,k′} in the adjacent layers V_{[r}_{ᵢ}_{,r}_{ᵢ₊₁}_{]} and V_{[r}_{ᵢ₊₁}_{,r}_{ᵢ₊₂}_{]} have a common area element.

r_{i,k,1}=r_{i,k,2}=r_{i,k,-1}=r_{i,k,-2}=rᵢ is set on each subdomain V_{i,k} that satisfies μ(V_{i,k})<δᵢμ(V_{[r}_{ᵢ}_{,r}_{ᵢ₊₁}_{]}), δᵢ<<1; otherwise, setting

$${{c}_{i}^{′} = {supX}_{i} , d {µ}^{c} {\vert}_{{V}_{i , k}} = {c}_{i}^{′} dv - d µ \vert}_{{V}_{i , k}} , \qquad ( 6 a )$$

$${\overline{r}}_{i , k} = {argmin}_{r} {\int }_{{V}_{i , k}} {\vert \vert x \vert - r \vert}^{2} d {µ}^{c} , \qquad ( 6 b )$$

and r_{i,k,1}=infᵣ{r:μ({x∈V_{i,k}:r̅_{i,k}<|x|<r})>ε}, r_{i,k,2}=supᵣ{r:μ({x∈V_{i,k}:r<|x|<rᵢ₊₁})>ε}, r_{i,k,-1}=supᵣ{r:μ({x∈V_{i,k}:r<|x|<r̅i,k})>ε}, and r_{i,k,-2}=infᵣ{r:μ({x∈V_{i,k}:rᵢ<|x|<r})>ε}, where ε represents an appropriately chosen threshold. In particular, the expression (6b) may be replaced by

$${\overline{r}}_{i , k} = {argmin}_{r} {\sum }_{x ∈ {V}_{i , k}} {\vert \vert x \vert - r \vert}^{2} {X}_{i , k} ( x )$$

locally to reduce the amount of calculation in the case that data in V_{i,k} comprise a small amount of discrete data points, where X_{i,k}(x)=0 if there exist no effective data at a point x.

If a certain given positive constant c has r_{i,k,1}−r_{i,k,-1}≥c·s₀, the subdomain V_{i,k} is partitioned into two along r=r̅_{i,k} to obtain two fine subdomains V′_{i,k} and V″_{i,k}, and r′_{i,k,2}=r_{i,k,2}, r′_{i,k,-2}=r_{i,k,1}, r″_{i,k,2}=r_{i,k,-1}, and r″_{i,k,-2}=r_{i,k,-2}. In other subdomains in V_{[r}_{ᵢ}_{,r}_{ᵢ₊₁}_{]}=r′_{i,k,2}=r_{i,k,2}, r′_{i,k,-2}=r″_{i,k,2}=r̅_{i,k}, and r″_{i,k,-2}=r_{i,k,-2}, or r′_{i,k,2}=r_{i,k,2}, r′_{i,k,-2}=r_{i,k,-2}, and r′_{i,k,2}=r″_{i,k-2}=rᵢ. In the above subdivision, in the case that μ(V′_{i,k})<δᵢμ(V_{[r}_{ᵢ}_{,r}_{ᵢ₊₁}_{]}), V′_{i,k} may be abandoned directly and r′_{i,k,2} and r′_{i,k-2} may not exist, while data in V″_{i,k} are reserved, and r′_{i,k,2}=r′_{i,k,-2}=rᵢ is set. The steps are repeated to traverse all subdomains V_{i,k}, so {V_{[r}_{ᵢ}_{,r}_{ᵢ₊₁}_{]}}_{i∈I} is updated till r_{i,k,1}−r_{i,k,-1} in each subdomain is a negligible quantity and finally a group of subdomains {V_{[r}_{ᵢ}_{,r}_{ᵢ₊₁}_{]}}_{i∈i+} is obtained. This process further subdivides a region where data distribution has a prominent geometric feature. For example, a region that contains unconnected parts is partitioned into two connected subdomains to be processed, which is an adaptive refinement.

In the subsequent operation, the subdomains obtained from finite times of partitions of V_{[r}_{ᵢ}_{,r}_{ᵢ₊₁}_{]} finite number of times of and the corresponding {r′_{i,k,2}, r′_{i,k,-2}}_{v′i,k} and {r″_{i,k,2}, r″_{i,k,-2}}_{v″}_{_{i,k}} . . . are pair-wise combined, for example a pair of {r′_{i,k,2}, r′_{i,k,-2}}_{v′}_{_{i,k}} is selected from V_{i,k} to be pair-wise matched with {r′_{i,k,2}, r′_{i,k,-2}} vim in from V_{j,m}, leading to a finite number of combinations {(r′_{i,2}, r′_{i,-2}):r′_{i,2}|v_{i,k}=r′_{i,k,2}, r′_{i,-2}|v_{i,k}=r′_{i,k,-2}} in V_{[r}_{ᵢ}_{,r}_{ᵢ₊₁}_{]} are obtained, where the number of combinations does not exceed the largest number of partition times among V_{i,k}'S.

The step S2 of setting an information selection mechanism F_{S}:X→F_{S}X according to a type of data distribution and decomposing data information in the three-dimensional space into multiple layers of spherical information F_{S}X for processing may, for example, adopt the following solution:
1_{W} is defined as the characteristic function of a set W in the three-dimensional space, a data distribution X=X_{c}=c_{W}·1_{W} is considered, namely, X is a non-zero constant c_{W} in a locally connected space set W and is 0 almost everywhere in its complement W^{c}. In the case that each concentric spherical layer V_{[r}_{ᵢ}_{,r}_{ᵢ₊₁}_{]} of {V_{[r}_{ᵢ}_{,r}_{ᵢ₊₁}_{]}}_{i∈I+} is fully refined, let

$$\{ \begin{matrix}{f}_{i}^{+} ( {ω}_{i , k} ) = \frac{{r}_{i , k , 2}}{{r}_{i}} \\ {f}_{i}^{-} ( {ω}_{i , k} ) = \frac{{r}_{i , k , - 2}}{{r}_{i}}\end{matrix} \qquad ( 7 )$$

be to-be-processed data, where ω_{i,k}=(θ_{i,k}, φ_{i,k}) corresponds to directional coordinates of a subdomain V_{i,k}, or briefly recorded as

$${f}_{i}^{+} = \frac{{r}_{i , 2}}{{r}_{i}} , {f}_{i}^{-} = \frac{{r}_{i , - 2}}{{r}_{i}} .$$

This is a particularly important type of data distribution. Just as the situation that planar shearlet system has been proved to be quite suitable for two-dimension cartoon-like images with certain regularity on a boundary, in the three-dimensional space, it can be assumed that W consists of a finite number of connected sets, and its boundary surface has good local regularity. For instance a three-dimensional cartoon figure, but is not limited to this type of data distribution in principle. In practice, the data to be analyzed usually exist in discrete forms, form a fitting or approximation of a three-dimensional figure with good regularity, while include some details and noise. For example, in biomedicine, when three-dimensional gray-scale image data of human body tissue is processed, usually much additional information is attached to a smooth organ image. A brain from inside to outside has apparent spherical distribution feature, especially its surface cortex, and lines and furrows of the cerebral surface exhibit anisotropic structures, which are suitable for being decomposed and reconstructed by the spherical shearlet. In addition to the biomedicine image data, it can be utilized when one performs physical simulation or models the Earth or distant stars. For example in a Saturn image captured by telescope, regular strips and rings surrounding the Saturn can be observed, which are suitable for being processed by the spherical shearlet system. As the magnification of the observing telescope increases, one gradually discovers asteroids or giant rocks distributed around celestial bodies-when only the distribution position of asteroids is interested, these scattered distributions can be treated as discrete data information.

When the noisy points are not a study object of interest, pre-processing denoising method including regularization models, neural networks and other means can be employed. However, some noisy points can be occasionally very interesting and important, and may exist in a discrete data form. Therefore, the case of including non-negligible discrete components X_{d}=Σ_{p∈D} dₚδₚ needs to be considered in the model sometimes, namely, X=X_{c}+X_{d}, where D is a bounded discrete subset in the three-dimensional space, dₚ is a positive integer, and δₚ is the delta distribution at the point p. The spherical shearlet is capable of detecting discrete singular points, and as a decomposition and reconstruction process that concerns only summation and integral operations without a derivation operation, it is relatively noise-robust compared with some conventional methods.

When data including Σₘ₌₁^{m̅}c_{W}_{ₘ}·1_{W}_{ₘ} and the discrete components X_{d} are processed, the following solution may be adopted:

Y is defined to be a blockwise constant distribution that satisfies Y|V_{i,k}=∫_{V}_{_{i,k}}Xdv in the case that D is a finite set. A set of {cₜ, {V′ₜ}}_{t≤t̅} is obtained deductively according to: c₁=minY|v_{i,k} together with a subdomain set {V′₁}=argminY|v_{i,k}, c₂=min_{V}_{_{i,k}}_{≠V}_{₁}, Y|_{V}_{_{i,k}}−c₁ together with a subdomain set {V′₂}=argmin_{V}_{_{i,k}}_{≠V}_{₁}, Y|_{V}_{_{i,k}}, and so on. Distributions Y₁|v_{i,k} and Yₜ|v_{i,k}'s are processed on each V_{[r}_{ᵢ}_{,r}_{ᵢ₊₁}_{]} in the same way as the data type X_{c}, to obtain a set of functions {((gᵢ⁺)ₜ, (gᵢ⁻)ₜ)}_{t≤t̅}, in which t̅=min{t:Yₜ|v_{i,k}=0, ∀V_{i,k} ⊂V_{[r}_{ᵢ}_{,r}_{ᵢ₊₁}_{]}}−1, and distributions Y₁|v_{i,k} and Yₜ|v_{i,k} are defined by the following expressions:

$${Y}_{1} {\vert}_{{V}_{i , k}} = \{ \begin{matrix}{c}_{1} , & Y {\vert}_{{V}_{i , k}} \neq 0 \\ 0 , & Y {\vert}_{{V}_{i , k}} = 0\end{matrix} \qquad ( 8 a )$$

$$⋮$$

$${Y}_{t} {\vert}_{{V}_{i , k}} = \{ \begin{matrix}Y {\vert}_{{V}_{i , k}} - {\sum }_{s < t} {c}_{s} , & Y {\vert}_{{V}_{i , k}} \neq 0 \\ 0 , & Y {\vert}_{{V}_{i , k}} = 0 or {V}_{i , k} ∈ {U}_{s < t} \{ {V}_{s}^{′} \}\end{matrix} \qquad ( 8 b )$$

The to-be-processed data of a layer V_{[r}_{ᵢ}_{,r}_{ᵢ₊₁}_{]} have expressions:

$$\{ \begin{matrix}{f}_{i}^{+} = {\sum }_{t \leq \overline{t}} {( {g}_{i}^{+} )}_{t} \\ {f}_{i}^{-} = {\sum }_{t \leq \overline{t}} {( {g}_{i}^{-} )}_{t}\end{matrix} \qquad ( 9 )$$

If the quantity of points in D is large and the distribution of X_{d} has a certain simple geometrical structure, an appropriate cost function may be set, and the discrete data are pre-processed to obtain a principal manifold or the main part of interest hidden under X_{d}, namely determine a dimensionality reduction mapping of X_{d}→X_{c}, to reduce corresponding data to the type of X_{c}, and to be processed by using the spherical shearlets.

A specific implementation of the step S3 is as follows:

The spherical information F_{S}X part that includes the to-be-processed data depending on the spherical coordinates in the expressions (7) or (9) is recorded as {xⁱ}_{i∈I+}={F_{S}Xᵢ}_{i∈I+}, spherical shearlet is decomposed according to the expression (4), and the coefficients {c_{j,k}^{i,+}}_{j,k} and {c_{j,k}^{i,-}}_{j,k} obtained from the spherical shearlet transform (5) are stored. The original three-dimensional space data distribution X may be approximated by a following expression:

$$\tilde{X} = {c}_{W} \cdot {\sum }_{i} ( {1}_{{U}_{i}^{+}} - {1}_{{U}_{i}^{-}} ) \qquad ( 10 )$$

where 1_{U}_{ᵢ}_{⁺} represents a characteristic function of a set Uᵢ⁺={x=|x|ω_{i,k}∈R³:|x|≤\tilde{x}^{i,+}(ω_{i,k})}, and 1_{U}_{ᵢ}_{^{−}} represents a characteristic function of a set Uᵢ⁻={x=|x|ω_{i,k}∈R³:|x|≤\tilde{x}^{i,-}(ω_{i,k})}, and the following relations are satisfied:

$${\tilde{x}}^{i , +} = {\tilde{x}}_{L}^{i , +} + {\tilde{x}}_{H}^{i , +} = {r}_{i} {\sum }_{l \leq L} {P}_{l} {x}^{i , +} + {r}_{l} {\sum }_{j , k} {c}_{j , k}^{i , +} {S}_{j , k} \qquad ( 11 a )$$

$${\tilde{x}}^{i , -} = {\tilde{x}}_{L}^{i , -} + {\tilde{x}}_{H}^{i , -} = {r}_{i} {\sum }_{l \leq L} {P}_{l} {x}^{i , -} + {r}_{l} {\sum }_{j , k} {c}_{j , k}^{i , -} {S}_{j , k} , \qquad ( 11 b )$$

so that on a finite (i, j, k) index set there are:

$${\sum }_{l} {‖ {x}^{i , +} - {x}_{L}^{i , +} - {\sum }_{j , k} {c}_{j , k}^{i , +} {S}_{j , k} ‖}_{B} \leq {ε}^{′} {\sum }_{i} {‖ {x}^{i , +} ‖}_{B} \qquad ( 12 a )$$

$${\sum }_{l} {‖ {x}^{i , -} - {x}_{L}^{i , -} - {\sum }_{j , k} {c}_{j , k}^{i , -} {S}_{j , k} ‖}_{B} \leq {ε}^{′} {\sum }_{i} {‖ {x}^{i , -} ‖}_{B} , \qquad ( 12 b )$$

where ε<<1 is chosen according to required accuracy, ∥·∥_{B} represents a norm that may reflect the data singular feature in space B adapted to the spherical shearlet system, and \tilde{x}_{H}ⁱ represents an approximation of the part of spherical data that is not of low degree. The corresponding shearlet coefficients have predictable sparsity in the case that F_{S}X has a curve linear singularity property on the sphere. The number of layers needing to be calculated is usually finite, so the overall calculation efficiency is determined by the efficiency of spherical shearlet representation.

Different from methods that are applied to data processing such as Fourier analysis, spline analysis and wavelet analysis under a conventional Cartesian coordinate system, the present disclosure provides a method for decomposing, compressing and reconstructing the three-dimensional space scalar data under the polar coordinate system by using the spherical shearlet system. Compared with conventional methods, the method based on spherical shearlet representation has predictable superiority in terms of processing the scalar data information with the spherical distribution feature in the three-dimensional space, especially with the linear singular distribution on the sphere.

What is claimed is:

1. A spherical shearlet-based compression and reconstruction method for three-dimensional scalar information, applied to decomposing, extracting, storing and reconstructing scalar data including three-dimensional geometric data having a spherical distribution feature and random data satisfying certain probability distributions, wherein the method comprises the following steps:
step S1: decomposing a three-dimensional space or a set V into concentric spherical layers, U_{i∈I} V_{[r}_{ᵢ}_{,r}_{ᵢ₊₁}_{]}=V, and partitioning, layer by layer, scalar data information X distributed in the three-dimensional space, wherein V represents an entire three-dimensional real space R³, or a bounded set comprising to-be-processed data; partitioning V into nonintersecting concentric spherical layers V_{[r}_{ᵢ}_{,r}_{ᵢ₊₁}_{]}, where i∈I, according to the scale or size s₀ of a local feature that needs to be extracted, wherein rᵢ₊₁−rᵢ∝S₀, U_{i∈I} V_{[r}_{ᵢ}_{,r}_{ᵢ₊₁}_{]}=V, and partitioning three-dimensional scalar data correspondingly into {Xᵢ}_{i∈I}, where Xᵢ represents data of X contained in the concentric spherical layers V_{[r}_{ᵢ}_{,r}_{ᵢ₊₁}_{]}, an index set/represents a finite set or a countable set in modeling sense and a finite set in actual operation sense; and
selecting different probability measures u to adapt to different types of data, and letting the restriction of the probability measures u on the concentric spherical layers V_{[r}_{ᵢ}_{,r}_{ᵢ₊₁}_{]} be dμ|v_{[r}_{ᵢ}_{,r}_{ᵢ₊₁}_{]}=Xᵢdv, wherein an analyzed three-dimensional data distribution is a continuous distribution or a discrete distribution;
step S2: setting a spherical layer selection mechanism F_{S}:X→F_{S}X={F_{S}Xᵢ}_{i∈I+} based on a type of the three-dimensional scalar data X, and extracting, layer by layer, spherical information to be processed by a discrete spherical shearlet system; and
defining 1_{W} as a characteristic function of a set W in the three-dimensional space, and considering a data distribution X=X_{c}=c_{W}·1_{W}, namely X is a non-zero constant c_{W} on a locally connected space set W and almost everywhere zero on its complement W^{c}, wherein when each concentric spherical layer V_{[r}_{ᵢ}_{,r}_{ᵢ₊₁}_{]} of {V_{[r}_{ᵢ}_{,r}_{ᵢ₊₁}_{]}}_{i∈I+} is fully refined, the to-be-processed data have expressions:
$$\{ \begin{matrix}{f}_{i}^{+} ( {ω}_{i , k} ) = \frac{{r}_{i , k , 2}}{{r}_{i}} \\ {f}_{i}^{-} ( {ω}_{i , k} ) = \frac{{r}_{i , k , - 2}}{{r}_{i}}\end{matrix} \qquad ( 1 )$$
where ω_{i,k}=(θ_{i,k}, φ_{i,k}) corresponds to directional coordinates of a subdomain V_{i,k}, or
$${f}_{i}^{+} = \frac{{r}_{i , 2}}{{r}_{i}}$$
and
step S3: decomposing, extracting and storing, by the discrete spherical shearlet system, the spherical data from each layer, to reconstruct data in the three-dimensional space, wherein the discrete spherical shearlet system has an expression:
$$\{ {S}_{j , k} := {S}_{{σ}_{j ,} {a}_{k}}^{α} \vert {σ}_{j} ∈ G , {a}_{k} ∈ ( 0 , ∞ ) , 0 < α < 1 \} \qquad ( 2 )$$
where {aₖ}_{k≥1} represents a sampling of the positive real axis, aₖ monotonically approach zero; index α represents a degree of anisotropy, and the smaller a value of the index α is, the higher the degree of anisotropy is; and G represents a finite or countable discrete subset of an orthogonal group SO(3), so that an integral of a square-integrable spherical function h on the orthogonal group SO(3) has a discrete expression:
$${〈 h 〉}_{SO ( 3 )} = {\sum }_{{σ}_{j} ∈ G} h ( {σ}_{j}^{- 1} {z}_{0} ) {w}_{j} \qquad ( 3 )$$
where z₀ represents a selected pole on a sphere, and wⱼ represents a weight; the discrete spherical shearlet system can be obtained from a single or a finite number of generation functions S^{α} through spherical dilation transform Dₐ and spherical rotation on a discretized parameter set, wherein when P₁ is a projection onto the space spanned by spherical harmonic functions of degrees n=1, . . . , l, and S^{α} satisfies a restriction condition:
$$\frac{1}{2 l + 1} {\int }_{0}^{∞} {‖ {P}_{l} {D}_{a} {S}^{α} ‖}_{2}^{2} {a}^{- 2 - α} da < ∞ , ∀ l \geq 0 \qquad ( 4 )$$
where in the discrete spherical shearlet system {S_{j,k}}_{j,k} has the function of stably decomposing and reconstructing spherical information and has an adjustable anisotropic support, namely, when S² is a two-dimensional sphere and R symbolizes real domain, inputted spherical information Xₛ:S²→R after normalization has a reconstruction formula:
$${X}_{s} = {\sum }_{l \leq L} {P}_{l} {X}_{s} + {\sum }_{{σ}_{j} ∈ G} {\sum }_{k} {\sum }_{l > L} {X}_{s , j} {P}_{l} {S}_{j , k} ( {σ}_{j}^{- 1} {z}_{0} ) {S}_{j , k} \qquad ( 5 a )$$
$${X}_{s , j} = {w}_{j} {X}_{s} ( {σ}_{j}^{- 1} {z}_{0} ) \qquad ( 5 b )$$
where L represents a positive integer, Xₛ represents a distribution or a random variable that satisfies a square integrable condition, and a spherical shearlet transform of Xₛ in discrete form has an expression:
$$SH ( {X}_{s} ; j , k ) = {\sum }_{l > L} {X}_{s , j} {P}_{l} {S}_{j , k} ( {σ}_{j}^{- 1} {z}_{0} ) \qquad ( 6 )$$
where PₗS_{j,k} is calculated prior to performing the spherical shearlet transform; decomposing, reconstructing data from each layer by the spherical shearlet according to the formula (5a), and storing corresponding coefficients {c_{j,k}^{i,+}}_{j,k} and {c_{j,k}^{i, -}}_{j,k} obtained from the spherical shearlet transform.

2. The spherical shearlet-based compression and reconstruction method for three-dimensional scalar information according to claim 1, wherein said partitioning, layer by layer, the set and the scalar data information in the step S1 comprises:
setting a threshold N_{b}<<μ(V), directly abandoning data in the concentric spherical layer V_{[r}_{ᵢ}_{,r}_{ᵢ₊₁}_{]} and letting Xᵢ=0, whenever a total data volume μ(V_{[r}_{ᵢ}_{,r}_{ᵢ₊₁}_{]})<N_{b} in V_{[r}_{ᵢ}_{,r}_{ᵢ₊₁}_{]}; or otherwise, further decomposing a data distribution in V_{[r}_{ᵢ}_{,r}_{ᵢ₊₁}_{]} into data distribution in each subdomain V_{i,k}, with V_{[r}_{ᵢ}_{,r}_{ᵢ₊₁}_{]}=UₖV_{i,k}, wherein subdomains V_{i,k} and V_{i+1,k′} are located in a cone defined by same radial sections with ∫X d\vec{v} as an apex when the subdomains V_{i,k} and V_{i+1,k′} in adjacent layers V_{[r}_{ᵢ}_{,r}_{ᵢ₊₁}_{]} and V_{[r}_{ᵢ₊₁}_{,r}_{ᵢ₊₂}_{]} have a common area element;
setting r_{i,k,1}=r_{i,k,2}=r_{i,k,-1}=r_{i,k,-2}=rᵢ on each subdomain V_{i,k} that satisfies μ(V_{i,k})<δᵢμ(V_{[r}_{ᵢ}_{,r}_{ᵢ₊₁}_{]}), and δᵢ<<1; otherwise, setting
$${{c}_{i}^{′} = {supX}_{i} , d {µ}^{c} {\vert}_{{V}_{i , k}} = {c}_{i}^{′} dv - d µ \vert}_{{V}_{i , k}} \qquad ( 7 a )$$
$${\overline{r}}_{i , k} = {argmin}_{r} {\int }_{{V}_{i , k}} {\vert \vert x \vert - r \vert}^{2} d {µ}^{c} \qquad ( 7 b )$$
and letting r_{i,k,1}=infᵣ{r:μ({x∈V_{i,k}:r̅_{i,k}<|x|<r})>ε}, r_{i,k,2}=supᵣ{r:μ({x∈V_{i,k}:r<|x|<rᵢ₊₁})>ε}, r_{i,k,-1}=supᵣ{r:μ({x∈V_{i,k}:r<|x|<r̅_{i,k}})>ε}, and r_{i,k,-2}=infᵣ{r:μ({x∈V_{i,k}:rᵢ<|x|<r})>ε}, where value & represents an appropriately chosen threshold;
replacing the expression (7b) by
$${\overline{r}}_{i , k} = {argmin}_{r} {\sum }_{x ∈ {V}_{i , k}} {\vert \vert x \vert - r \vert}^{2} {X}_{i , k} ( x )$$
to reduce the amount of calculation when data in V_{i,k} comprise a small amount of discrete data points;
partitioning the subdomain V_{i,k} into two along r=r̅_{i,k} to obtain two fine subdomains V′_{i,k} and V″_{i,k} when a certain given positive constant c satisfies r_{i,k,1}−r_{i,k,-1}≥c·s₀, letting r′_{i,k,2}=r_{i,k,2}, r′_{i,k,-2}=r_{i,k,1}, r″_{i,k,2}=r_{i,k,-1}, and r″_{i,k-2}=r_{i,k,-2}; while in other subdomains, letting r′_{i,k,2}=r_{i,k,2}, r′_{i,k,-2}=r″_{i,k,2}=r̅_{i,k}, r″_{i,k,-2}=r_{i,k,-2} or let r′_{i,k,2}=r_{i,k,2}, r′_{i,k,-2}=r_{i,k,-2}, and r″_{i,k,2}=r″_{i,k,-2}=rᵢ; repeating such steps to traverse all subdomains V_{i,k}, keeping {V_{[r}_{ᵢ}_{,r}_{ᵢ₊₁}_{]}}_{i∈I} being updated till r_{i,k,1}−r_{i,k,-1} in each subdomain has become a negligible quantity, resulting in a set of subdomains {V_{[r}_{ᵢ}_{,r}_{ᵢ₊₁}_{]}}_{i∈I+}; and
after finite times of partitions, pairing and combining the subdomains of V_{[r}_{ᵢ}_{,r}_{ᵢ₊₁}_{]} together with their {r′_{i,k,2}, r′_{i,k,-2}}v′_{i,k}, {r″_{i,k,2}, r″_{i,k,-2}}v″_{i,k} . . . to obtain a finite set {(r′_{i,2}, r′_{i,-2}):r′_{i,2}|v_{i,k}=r′_{i,k,2}, r′_{i,-2}|v_{i,k}=r′_{i,k,-2}} in V_{[r}_{ᵢ}_{,r}_{ᵢ₊₁}_{]}.

3. The spherical shearlet-based compression and reconstruction method for three-dimensional scalar information according to claim 2, wherein one approach of the step S2 comprises:
adopting a processing solution presented below, when data distributions X=Σₘ₌₁^{m̅}c_{W}_{ₘ}·1_{W}_{ₘ} or X=X_{c}+X_{d} comprises a non-negligible discrete component X_{d}=Σ_{p∈D}dₚδₚ, where D represents a finite discrete subset in the three-dimensional space, dₚ represents a positive integer, and δₚ represents the delta distribution at a point p:
defining Y to be a blockwise constant distribution that satisfies Y|v_{i,x}=∫V_{i,k}Xdv, and letting {cₜ, {V′ₜ}}_{t≤t̅}, be a set defined deductively according to: c₁=minY|V_{i,k} together with a subdomain set {V′₁}=argminY|v_{i,k}, c₂=min_{V}_{_{i,k}}_{≠V′}_{₁}Y|V_{i,k}−c₁ together with a subdomain set {V′₂}=argmin_{V}_{_{i,k}}_{≠V′}_{₁}Y|V_{i,k}, and so on; and on each V_{[r}_{ᵢ}_{,r}_{ᵢ₊₁}_{]}, defining distributions Y₁|v_{i,k} and Yₜ|v_{i,k} deductively as
$${Y}_{1} {\vert}_{{V}_{i , k}} = \{ \begin{matrix}{c}_{1} , & Y {\vert}_{{V}_{i , k}} \neq 0 \\ 0 , & Y {\vert}_{{V}_{i , k}} = 0\end{matrix} \qquad ( 8 a )$$
$$⋮$$
$${Y}_{t} {\vert}_{{V}_{i , k}} = \{ \begin{matrix}Y {\vert}_{{V}_{i , k}} - {\sum }_{s < t} {c}_{s} , & Y {\vert}_{{V}_{i , k}} \neq 0 \\ 0 , & Y {\vert}_{{V}_{i , k}} = 0 or {V}_{i , k} ∈ {U}_{s < t} \{ {V}_{s}^{′} \}\end{matrix} \qquad ( 8 b )$$
where each of distributions Y₁|v_{i,k} and Yₜ|v_{i,k} is processed in the same way as processing data type X_{c}, to obtain a set of functions {((gᵢ⁺)ₜ, (gᵢ⁻)ₜ)}_{t≤t̅}, in which t̅=min{t:Yₜ|v_{i,k}=0, ∀V_{i,k}⊂V_{[r}_{ᵢ}_{,r}_{ᵢ₊₁}_{]}}−1; and letting
$$\{ \begin{matrix}{f}_{i}^{+} = {\sum }_{t \leq \overline{t}} {( {g}_{i}^{+} )}_{t} \\ {f}_{i}^{-} = {\sum }_{t \leq \overline{t}} {( {g}_{i}^{-} )}_{t}\end{matrix} \qquad ( 9 )$$
be a pair of to-be-processed data from layer V_{[r}_{ᵢ}_{,r}_{ᵢ₊₁}_{]}.

4. The spherical shearlet-based compression and reconstruction method for three-dimensional scalar information according to claim 3, wherein one approach of the step S3 comprises:
denoting the spherical data information that comprises the to-be-processed data depending on spherical coordinates in the expression (1) or the expression (9) as {xⁱ}_{i∈I+}={F_{S}Xᵢ}_{i∈I+}, decomposing the spherical shearlet according to the expression (5a), and storing the coefficients {c_{j,k}^{i,+}}_{j,k} and {c_{j,k}^{i,-}}_{j,k} obtained from the spherical shearlet transform, wherein the original three-dimensional space data distribution X is approximated by:
$$\tilde{X} = {c}_{W} \cdot {\sum }_{i} ( {1}_{{U}_{i}^{+}} - {1}_{{U}_{i}^{-}} ) \qquad ( 10 )$$
where 1_{U}_{ᵢ}_{⁺} represents the characteristic function of a set Uᵢ⁺={x=|x|ω_{i,k}∈R³: |x|≤\tilde{x}^{i,+}(ω_{i,k})}, 1_{U}_{ᵢ}_{^{−}} represents the characteristic function of a set Uᵢ⁻={x=|x|ω_{i,k}∈R³: |x|≤\tilde{x}^{i,-}(ω_{i,k})}, and following relations are satisfied:
$${\tilde{x}}^{i , +} = {\tilde{x}}_{L}^{i , +} + {\tilde{x}}_{H}^{i , +} = {r}_{i} {\sum }_{l \leq L} {P}_{l} {x}^{i , +} + {r}_{i} {\sum }_{j , k} {c}_{j , k}^{i , +} {S}_{j , k} \qquad ( 11 a )$$
$${\tilde{x}}^{i , -} = {\tilde{x}}_{L}^{i , -} + {\tilde{x}}_{H}^{i , -} = {r}_{i} {\sum }_{l \leq L} {P}_{l} {x}^{i , -} + {r}_{i} {\sum }_{j , k} {c}_{j , k}^{i , -} {S}_{j , k} , \qquad ( 11 b )$$
so that following requirements are satisfied on a finite (i, j, k) index set:
$${\sum }_{i} {‖ {x}^{i , +} - {x}_{L}^{i , +} - {\sum }_{j , k} {c}_{j , k}^{i , +} {S}_{j , k} ‖}_{B} \leq {ε}^{′} {\sum }_{i} {‖ {x}^{i , +} ‖}_{B} \qquad ( 12 a )$$
$${\sum }_{i} {‖ {x}^{i , -} - {x}_{L}^{i , -} - {\sum }_{j , k} {c}_{j , k}^{i , -} {S}_{j , k} ‖}_{B} \leq {ε}^{′} {\sum }_{i} {‖ {x}^{i , -} ‖}_{B} \qquad ( 12 b )$$
where ε′<<1 is chosen according to required accuracy, ∥·∥_{B} represents a norm that reflects data singular feature in a space B adapted to the spherical shearlet system, and \tilde{x}_{H}ⁱ represents an approximation of a part of spherical data that is not of low degree.
